(19) United States
(12) Patent Application Publication
(10) Pub. No.: US 2013/0063597 A1
(43) Pub. Date: Mar. 14, 2013

(54) METHOD FOR IMAGE PROCESSING OF IMAGE DATA RECORDED WITH AN OPTICAL SENSOR IN A MOTOR VEHICLE, AND A MOTOR VEHICLE

(71) Applicants: Stefan Wender, Ingolstadt (DE); Mirko Mählisch, Gaimersheim (DE); Alexander Kleinsorge, Berlin (DE)

(72) Inventors: Stefan Wender, Ingolstadt (DE); Mirko Mählisch, Gaimersheim (DE); Alexander Kleinsorge, Berlin (DE)

(73) Assignee: Audi AG, Ingolstadt (DE)

(21) Appl. No.: 13/605,568

(22) Filed: Sep. 6, 2012

(30) Foreign Application Priority Data
Sep. 13, 2011 (DE) 10 2011 113 265.5

(51) Int. Cl. G06K 9/78; H04N 7/18

(52) U.S. Cl. 348/148; 382/103; 348/E07.085

(57) ABSTRACT

In a method for image processing of image data recorded in a motor vehicle with an optical sensor, in particular with a camera, wherein the image data include images sequentially recorded with a defined image recording rate, an optical flux is determined from the image data and useful information is determined from the optical flux by at least one vehicle system, in particular a driver assist system. The optical flux is determined during compression of the image data and/or from flux information determined during the compression of the image data.

### CROSS-REFERENCES TO RELATED APPLICATIONS

This application claims the priority of German Patent Application, Serial No. 10 2011 113 265.5, filed Sep. 13, 2011, pursuant to 35 U.S.C. 119(a)-(d), the content of which is incorporated herein by reference in its entirety as if fully set forth herein.

### BACKGROUND OF THE INVENTION

The present invention relates to a method for image processing of image data recorded in a motor vehicle with an optical sensor, in particular a camera. The invention also relates to a motor vehicle employing the method.

The following discussion of related art is provided to assist the reader in understanding the advantages of the invention, and is not to be construed as an admission that this related art is prior art to this invention.

It is known to provide cameras in motor vehicles which continuously monitor the environment of a motor vehicle. The camera records images at a defined image rate. These images can be evaluated in the motor vehicle by corresponding control devices so as to determine information required by driver assist systems and other vehicle systems, for example in form of an environmental model and the like.

An important part of today's image processing for vehicle systems, in particular driver assist systems, is the determination of the optical flux. The optical flux is a vector field which indicates the direction and the speed with which a subregion of an image, for example a pixel or several pixel, move. The optical flux is used, for example, to separate moving objects from a non-moving objects and the like. Disadvantageously, determination of the optical flux requires a larger quantity of resources, i.e. it is very complex. A large computing capacity must be provided which is a substantial component of hardware costs of systems in a motor vehicle.

It has already been proposed to process images in a motor vehicle centrally, which requires transmission of the image data from the camera with a high transmission bandwidth, in particular via a dedicated communication link, to an in particular central control device.

It would therefore be desirable and advantageous to obviate prior art shortcomings and to provide an improved method for processing images in motor vehicles which is less complex and less expensive.

### SUMMARY OF THE INVENTION

According to one aspect of the present invention, a method for image processing of image data comprising sequential images recorded with a defined image recording rate in a motor vehicle using an optical sensor includes the steps of determining from the image data an optical flux during compression of the image data or from flux information obtained during the compression of the image data, and determining with at least one vehicle system from the optical flux useful information.

The invention is therefore based on the realization that an optical flux or at least its foundation needs to be determined anyway when compressing image data. Whereas early compression methods for image data sequentially recorded with a defined image recording rate are limited to coarsely indicate where a change in consecutive images has taken place, newer methods also indicate the direction and speed of the change, thereby generating an optical flux in form of a motion vector field essentially as a “byproduct.” The compression “clusters” the images in image regions, with the size of the image regions depending on how much loss or how little loss can be tolerated. An optical flux is also contained as a motion vector field in the flow of the compressed image data with the same amount of detail or coarseness; however, this information is typically discarded again after the image data are decoded.

The present invention now proposes to additionally read this information out. When the motion vector field determined during the compression has already enough details, it can be used directly as optical flux. However, within the context of the present invention, the flux information may also be used as input data for initializing a computation method for the optical flux. In other words, flux information extracted with the compression method can be used for initializing detailed flux computation methods as a preprocessing step. In this way, very detailed flux computation methods can be implemented, while further reducing computing time in the first steps of such algorithms.

It would basically be feasible to use solely the compression of the image data for determining the optical flux. For example a microchip specifically designed for effectively performing the compression may be installed in the control device that evaluates the image data. The use of such dedicated chips which have special command sets for effectively performing the computing steps required for determining the optical flux makes sense because such “compression chips” are already commercially available. Using them here, although in a different application, can reduce the demands on the processor hardware of the remaining image processing. Less powerful and less expensive processor hardware can then be employed, while simultaneously reducing computing time and energy consumption due to the efficiency of the computation.

According to an advantageous feature of the present invention, image data may be transmitted via a transmission line, to compress the image data before transmission via a transmission line. Transmission of the image data requires a large transmission bandwidth, as mentioned above, which is nowadays realized by using expensive transmission media, meaning expensive communication links. However, a suitable compression of the image data can also be used, so that compression within the context of the present invention is essentially used “twice”, namely on one hand for advantageously transmitting the image data and, on the other hand, also within the context of determining the optical flux. Advantageously, synergetic effects from intermediate results of the image compression may also be used for the image processing in driver assist systems. In actuality, the compressed image data and the motion vectors, which are also transmitted in conjunction with the compression, may be read out downstream of the transmission line. The motion vector field of the compression method is hence also read out from the transmitted data stream, in addition to the decoded image. The thereby extracted optical flux may be used, on one hand, directly in lieu of the motion vectors which have been used thus far and which were explicitly computed for image processing, or also for various functions in lieu of similar approaches based on the identification of a shift of image contents. The computing time is thus significantly reduced, allowing as mentioned above the use of lower-priced processors and assemblies, which also improves the energy balance and advantageously reduces the weight of the entire image processing device.

The present invention thus provides various advantages through improvement of the energy efficiency and reduction of the weight, as well as additionally through the reduction of the acquisition costs of the individual components of the image processing device.

According to an advantageous feature of the present invention, a microchip which is specifically constructed for effectively carrying out the compression may be used for the compression. As already mentioned, such chips which have recently become more and more common may include special command sets for effectively performing the compression.

According to another advantageous feature of the present invention, the H264 method or an MJPEG may be used as compression method. The H264 method is preferred. However, motion vector fields may also be determined with the MJPEG method (Motion JPEG).

According to another aspect of the present invention, a motor vehicle includes an optical sensor, in particular a camera, and a device for image processing of image data recorded with the camera. The image processing device is configured to determine from the image data an optical flux during compression of the image data or from flux information obtained during the compression of the image data and determine with at least one vehicle system from the optical flux useful information. All features relating to the method of the invention can also be applied to the motor vehicle according to the invention, so that the motor vehicle attains the same advantages. More particularly, the device for image processing may include a microchip (“compression chip”) specifically constructed for effectively carrying out the compression.

According to another advantageous feature of the present invention, a chip for compressing the image data and a transmission line for transmitting the compressed image data to a control device, which performs the additional image processing, may be arranged downstream of the camera. This arrangement produces particular synergetic effects, because the compression method is used both for a more advantageous transmission of the image data as well as for determining the optical flux. The transmission line may, for example, be a dedicated line; advantageously, the control device may also be a central control device for the image processing which then distributes the determined information to the additional vehicle systems, in particular via a bus.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 shows a schematic diagram of a motor vehicle according to the present invention, and

FIG. 2 shows a schematic diagram of the method according to the present invention.

### DETAILED DESCRIPTION OF PREFERRED EMBODIMENTS

Throughout all the figures, same or corresponding elements may generally be indicated by same reference numerals. These depicted embodiments are to be understood as illustrative of the invention and not as limiting in any way. It should also be understood that the figures are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted.

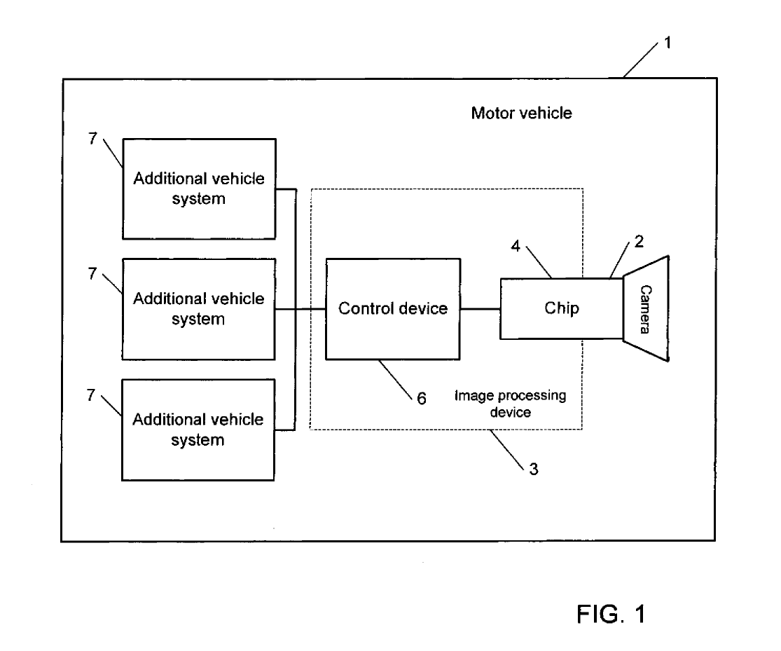

Turning now to the drawing, and in particular to FIG. 1, there is shown a schematic diagram of a motor vehicle 1 according to the present invention. The motor vehicle 1 includes at least a camera 2 which records images of the environment of the motor vehicle 1 with a defined image recording rate; the images are then further processed with an image processing device 3 configured to process the image data recorded with the camera 2. The image processing device 3 includes a chip 4 for compressing the image data according to the H264 method which is arranged immediately following the camera 2 in the transport direction of the image data. The compressed image data are then transmitted via a transmission line 5, in the present example a dedicated line, to a control device 6 for further image processing. The control device 6 determines useful information from the image data for additional vehicle systems 7, in particular for driver assist systems, as is generally known in the art.

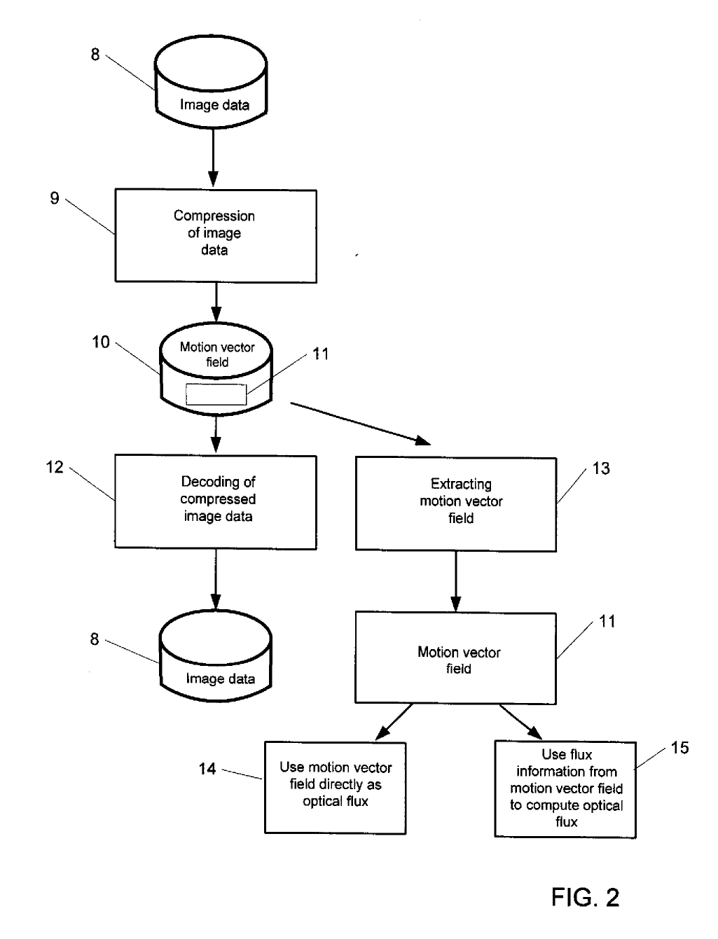

The image processing device 3 is configured for performing the method according to the invention, which will now be described in more detail with reference to FIG. 2. First, the image data 8 from the camera 2 are compressed at a step 9 in the chip 4 according to the H264 method. Compressed image data 10 are then generated which also include a motion vector field 11 which indicates the direction and the speed with which the particular image regions move.

The compressed image data 10 are transported via the transmission line 5 where they are, on one hand, decoded in a conventional manner at step 12, so that the image data 8 are again obtained, potentially with small losses, depending on the accuracy of the compression method; on the other hand, at a step 13, the motion vector field 11 is additionally extracted from the compressed image data 10 and further processed in two different ways. On one hand, when the motion vector field 11 is sufficiently accurate, for example when small image areas are considered in the compression method, the motion vector field 11 can be used directly as an optical flux in at least a portion of the functions and vehicle systems 7 that require the optical flux, step 14. However, the motion vector field 11 may also be used as flux information in order to initialize a more accurate computation method for the optical flux, step 15.

The compression method at step 9 has therefore two advantages, namely on one hand for the transmission of the image data, and on the other hand for determining the optical flux or at least as preprocessing step for determining the optical flux.

While the invention has been illustrated and described in connection with currently preferred embodiments shown and described in detail, it is not intended to be limited to the details shown since various modifications and structural changes may be made without departing in any way from the spirit and scope of the present invention. The embodiments were chosen and described in order to explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

1. A method for image processing of image data comprising sequential images recorded with a defined image recording rate in a motor vehicle using an optical sensor, comprising the steps of:
determining from the image data an optical flux during compression of the image data or from flux information obtained during the compression of the image data, and
determining with at least one vehicle system from the optical flux useful information.

2. The method of claim 1, wherein the obtained flux information is used as input data for initializing a computation method for the optical flux.

3. The method of claim 1, wherein the image data are transmitted via a transmission line and the image data are compressed before being transmitted via the transmission line.

4. The method of claim 3, wherein the compressed image data and motion vectors derived as a result of the compression are transmitted together and read out downstream of the transmission line.

5. The method of claim 1, wherein the image data are compressed using a microchip specifically designed for efficiently performing the compression.

6. The method of claim 1, wherein the image data are compressed using H264 or MJPEG compression.

7. The method of claim 1, wherein the optical sensor comprises a camera.

8. The method of claim 1, wherein the at least one vehicle system comprises a driver assist system.

9. A motor vehicle, comprising:
an optical sensor, and
a device for image processing of image data recorded with the optical sensor, wherein the device for image processing is configured to
determine from the image data an optical flux during compression of the image data or from flux information obtained during the compression of the image data, and
determine with at least one vehicle system from the optical flux useful information.

10. The motor vehicle of claim 9, further comprising
a chip for compressing the image data,
a control device, which performs additional image processing, and
a transmission line for transmitting the compressed image data from the chip to the control device,
wherein the chip, the control device and the transmission line are arranged downstream of the optical sensor.

11. The motor vehicle of claim 9, wherein the optical sensor comprises a camera.
